(19) United States
(12) Patent Application Publication
(10) Pub. No.: US 2011/0299854 A1
(43) Pub. Date: Dec. 8, 2011

(54) Light Bulb with IR Transmitter

(75) Inventors: Karl Jonsson, Rancho Santa Margarita, CA (US); Vito Sansevero, Laguna Hills, CA (US)

(73) Assignee: Greenwave Reality, Inc., Irvine, CA (US)

(21) Appl. No.: 12/795,351

(22) Filed: Jun. 7, 2010

(51) Int. Cl. H04B 10/10

(52) U.S. Cl. 398/106

(57) ABSTRACT

A lighting module is disclosed that integrates a controller capable of receiving data from a source outside of the module, and then sending out an IR command to control a consumer electronics component based on the data received. The lighting module could be light bulb, a lighting fixture, a subcomponent of a lighting apparatus, or any other apparatus that incorporates both an illumination source and the controller for receiving data and sending out the IR command for controlling consumer electronics.

### BACKGROUND

1. Technical Field

The present subject matter relates to lighting apparatus, especially lighting fixtures and light bulbs. It further relates to the ability to controlling consumer electronics equipment with commands modulated onto infrared light sent from the lighting apparatus

2. Description of Related Art

In the past, most lighting systems used incandescent or florescent light bulbs for illumination. As light emitting diode (LED) technology improves, it is being used more and more for general illumination purposes. In many cases, LED based light bulbs are a direct replacement for a traditional incandescent or florescent light bulb and do not include any other functionality.

Light emitting diodes (LEDs) were originally developed to provide visible indicators and information displays. For such luminance applications, the LEDs emitted relatively low power. However, in recent years, improved LEDs have become available that produce relatively high intensities of output light. These higher power LEDs, for example, have been used in arrays for traffic lights. Today, LEDs are available in almost any color in the color spectrum.

In some cases, however, additional functionality is included with an apparatus utilizing LEDs for illumination. In U.S. Pat. No. 7,521,667, issued on Apr. 21, 2009, the inventors Rains et al. disclose a light fixture, using one or more solid state light emitting elements utilizing a diffusely reflect chamber to provide a virtual source of uniform output light, at an aperture or at a downstream optical processing element of the system. Systems disclosed by Rains et al. also include a detector, which detects electromagnetic energy from the area intended to be illuminated by the system, of a wavelength absent from a spectrum of the combined light system output and an. A system controller is responsive to the signal from the detector. The controller typically may control one or more aspects of operation of the solid state light emitters, such as system ON-OFF state or system output intensity or color. Examples are also discussed that use the detection signal for other purposes, e.g. to capture data that may be carried on electromagnetic energy of the wavelength sensed by the detector.

The system controller disclosed by Rains, at al. receives the signal from the detector which in some embodiments may represent a remote control command. They further disclose that the system controller may use the signal from the detector to capture data that may be carried on electromagnetic energy of the particular wavelength sensed by the detector, which in some cases may be sensitive to infrared (IR) light. For two-way communication, the controller might modulate the drive of IR emitters with downlink data, and the light sensed by the detectors would carry the uplink data. The data communications capabilities offered by the IR emitters and the IR sensitive detectors could be used for two-way communication of data regarding system operation, e.g. remote control and associated responsive signaling. However, these communications could enable use of the system for more general two-way data communications, e.g. as a two-way wireless interface to a data network. The need to control consumer electronic equipment, however, is not addressed by Rains, et al. in any way.

One of the pervasive features of consumer electronics equipment, such as audio and video electronic components, has been and continues to be the handheld remote control. The handheld remote control sends control signals to the controlled device by irradiating the device with infrared energy generated by infrared LEDs. The controlled device receives a pattern of intermittent irradiation or illumination comprising a control signal.

The remote control unit has stored patterns corresponding to push buttons assigned to various functions of the controlled device. Activating a button causes the excitation of the LED according to the stored pattern, thereby generating and transmitting a control signal. Control signals tend to be short words of data representing a low order numeric signal corresponding to some function of the controlled electronic appliance. Many infrared (IR) remote control units use a carrier frequency of between 30 kHz and 60 kHz, although some use a carrier frequency of 455 kHz and others use a carrier frequency of 1125 kHz. The controlled device receives the signal with an infrared photo detection diode and circuitry that interprets as logical lows and highs the alternating illumination of the LED on the remote control unit. Such a signal corresponds to the pattern stored in the remote control unit.

Various manufacturers have selected unique numeric codes to control their devices. This unique coding has allowed differentiation between such devices. For instance, a Brand X VCR will have a limited vocabulary of signals that influence its action. The Brand Y television will have a different limited vocabulary of signals. If a signal is not present within a device's vocabulary, the device will do nothing. With several devices, each having a distinct and limited vocabulary, a single universal remote control can control all of them, distinctly.

While infrared transmission of control signals is an inexpensive and reliable means of controlling one or more devices, it suffers from several shortcomings. The remote control unit transmits much as a flashlight illuminates. All transmissions propagate strictly along lines of sight. If walls, enclosures, furniture, or people block the path between the remote control unit and the controlled device, the controlled signal is occluded and the device cannot respond. A VCR in a cabinet enclosure will not respond.

Further, as in an auditorium or restaurant, if several of the same brand and model of device are present, a single signal might affect a plurality of those devices present. As only those of the units that the remote control unit illuminates by the emission of its photo emitter diode will receive the signal, the number of units that respond may not always be uniform or predictable.

In U.S. Pat. No. 4,809,359, issued Feb. 28, 1989, and U.S. Pat. No. 5,142,397, issued Aug. 25, 1992, the inventor Dockery discloses a system for extending the range of an infrared remote control system. The system comprises two units known as repeaters. The first repeater receives the infrared control signal from the handheld remote control unit and translates that signal to a corresponding UHF radio frequency signal. The second repeater, located remotely from the first and adjacent to the controlled device, receives the UHF signal and reconstitutes it into an infrared control signal equal to that the handheld remote control unit sent to the first repeater. The controlled device then receives it and responds just as it would to the handheld remote control unit.

The advantage to the Dockery system is that a signal that will pass through obstructions. The handheld remote control and first repeater of the Dockery patent can control a VCR and second repeater entirely enclosed within a cabinet or even in a second room. Such a system of repeaters allows for a home entertainment system that is inconspicuous within a room or a centrally wired programming center that is remote from the television unit.

The Dockery invention has several disadvantages however. Principal among those disadvantages is the lack of selectivity. The infrared remote control device will transmit only within a single room and within that room only to those devices illuminated by the photo emitter diode. The first repeater in Dockery's patent, on the other hand, will transmit through walls and other structures. In a home, apartment building, or other area with multiple repeater sets present, one first repeater can be in signal communication with several of the second repeater units. This “crosstalk” between signal units may result in the unintended control of several controlled devices, especially devices outside of the presence of the viewer or listener.

In U.S. Pat. No. 5,227,780, issued on Jul. 13, 1993, the inventor Tigwell discloses a method for controlling a consumer electronics device designed to be controlled by infrared commands by using a remote control that transmits a UHF radio frequency signal to a receiver. The receiver accepts the UHF radio frequency signal and then transmits a corresponding infrared control signal to the consumer electronics device. By integrating the UHF radio frequency transmitter directly into the remote control, the system disclosed by Tigwell has the advantage of eliminating the need for a separate device to translate infrared command into a UHF radio frequency transmission.

Stevenson, et al., the inventors of U.S. Pat. No. 7,062,175, issued on Jun. 13, 2006 and U.S. Pat. No. 7,574,141, issued on Aug. 11, 2009, disclose a similar system to that of Dockery, but they also include a method of pairing a transmitter to a receiver to avoid the problem of transmitting a command to an unintended receiver.

Each of these IR control extenders requires a separate unit to receive the UHF radio frequency signal and convert it to the corresponding IR command. In many installations, the presence of another piece of equipment is undesirable. It would therefore be advantageous to include the function of converting the UHF radio frequency signal to the corresponding IR command into another device that is already included in most rooms so that no unsightly additional box is needed.

### SUMMARY

The lighting module disclosed integrates a controller capable of receiving data from a source such as the transmitter disclosed by Dockery or Stevenson, et al. or any other device outside of the lighting module, and then sending out an IR command to control a consumer electronics component. The lighting module could be light bulb, a lighting fixture, a subcomponent of a lighting apparatus, or any other apparatus that incorporates both an illumination source and the controller for receiving data and sending out the IR command for controlling consumer electronics.

A lighting module as disclosed herein includes a visible light source for illumination. Any technology could be used for the visible light source and any illumination level could be addressed, but to truly be a source for illumination it should output at least the equivalent of a 5 W incandescent bulb, or at least 25 lumens of luminous flux. In one embodiment, the visible light source is comprised of one or more LEDs where the combined output of these LEDs may provide a white light. In an alternative embodiment, the visible light source could be implemented using a socket that provides power to a separate light bulb or other lighting module.

The lighting module also includes an infrared LED that is used to transmit the IR command. In an alternative embodiment, the visible light source also emits enough infrared light that no separate infrared LED is required.

The lighting module also has a controller that includes a data receiver for receiving data from another device and a drive circuit that controls the infrared LED to send out IR commands to control the consumer electronics component. The controller may include other functions in some embodiments. If the data received is already modulated to control the consumer electronics component, the controller may simply pass the received data to the drive circuit unchanged. If the data received is not already modulated to control the consumer electronics component, the controller also includes circuitry to convert the received data into a protocol for controlling a consumer electronics component. The controller may also include circuitry to control the visible light source. It may control the on-off state, the brightness, the color, the color temperature or any other characteristic of the visible light source. The circuitry to transform the received data and control the visible light source may be implemented in a microcontroller in some embodiments. The data is then sent out as an IR command using one of several common protocols used for consumer electrics. These protocols require a carrier of 30-60 kHz, 455 kHz or 1125 kHz. The lighting module is not configured for two-way communication with the consumer electronics component targeted by the IR commands.

The data receiver may be configured to accept a signal in one of many different forms, depending on the embodiment. One embodiment might receive and demodulate a radio frequency signal. In other embodiments, it may receive and demodulate an optical signal where that optical signal could be infrared, ultraviolet or visible light. The incoming optical signal could be modulated using a consumer electronics control protocol, a standard data protocol, or a proprietary signaling protocol. In yet another embodiment, the receiver may decouple a signal from the incoming power line and demodulate that to retrieve the data. In yet other embodiments, the data receiver may have a wired connection to a baseband data bus or network such as USB or Ethernet.

The lighting module as disclosed herein includes structure to join the visible light source, the infrared LED and the controller into an integrated unit. In some embodiments, this structure may take the form of a traditional light bulb made of glass or a polymeric material, such a transparent plastic, containing the entire lighting module, with a traditional base including contacts for receiving power from a socket.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1 illustrates an overview of the lighting module;

FIG. 2 shows an alternative embodiment of the lighting module where the visible light and infrared light are both emitted by a broadband LED;

FIG. 3 demonstrates the basic functionality of the controller;

FIGS. 4A, 4B and 4C illustrate alternative implementations of the data receiver;

FIG. 4D shows a diagram of the controller without the data receiver;

FIGS. 5A and 5B illustrate basic modulation for consumer electronics IR commands.

FIG. 6 gives a pictorial representation of the lighting module in a room controlling a consumer electronics component.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures and components have been described at a relatively high-level, without detail, in order to avoid unnecessarily obscuring aspects of the present concepts. A number of descriptive terms and phrases are used in describing the various embodiments of this disclosure. These descriptive terms and phrases are used to convey a generally agreed upon meaning to those skilled in the art unless a different definition is given in this specification. Some descriptive terms and phrases are presented in the following paragraphs for clarity.

The term “LED” refers to a diode that emits light, whether visible, ultraviolet, or infrared, and whether coherent or incoherent. The term as used herein includes incoherent polymer-encased semiconductor devices marketed as “LEDs”, whether of the conventional or super-radiant variety. The term as used herein also includes semiconductor laser diodes and diodes that are not polymer-encased. It also includes LEDs that include a phosphor or nanocrystals to change their spectral output.

The term “visible light” refers to light that is perceptible to the unaided human eye, generally in the wavelength range from about 400 to 700 nm.

The term “ultraviolet” or “UV” refers to light whose wavelength is in the range from about 200 to about 400 nm.

The term “infrared” or “IR” refers to light whose wavelength is in the range from about 700 to about 2000 nm.

The term “white light” refers to light that stimulates the red, green, and blue sensors in the human eye to yield an appearance that an ordinary observer would consider “white”. Such light may be biased to the red (commonly referred to as warm color temperature) or to the blue (commonly referred to as cool color temperature).

Reference now is made in detail to the examples illustrated in the accompanying drawings and discussed below.

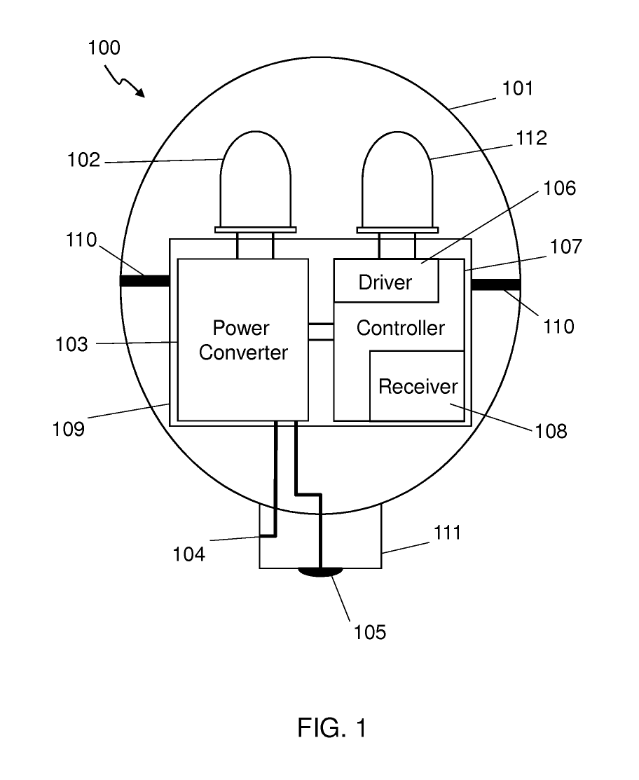

Referring to FIG. 1, lighting module 100 includes a visible light source 102 to provide illumination. As an illumination source, the luminous flux output should be at least equivalent to a 5 W incandescent light, or 25 lumens or greater. In one embodiment, the visible light source 102 is a plurality of red, green and blue LEDs. In another embodiment, the visible light source 102 is one or more white light LEDs. In other embodiments, the visible light source 102 could be any combination of LEDs, an incandescent light, a fluorescent light or any other type of light emitting device. In other embodiments the lighting module 100 may not directly include the visible light source but may include a socket with power contacts to provide power to a light bulb or other separate visible light source.

The visible light source 102 is connected to a power converter 103 that receives electrical power from external power contacts 104 and 105. The electrical power received from the external power contacts 104 and 105 may be direct current (DC) or alternating current (AC) and may be one of many different voltages depending on the target application of a particular embodiment. Voltages that may be received from the external power contacts 104 and 105 include common household voltages of 100-250 Volts AC (VAC) at 50 or 60 Hz. They also might be common battery based voltages such multiples of 1.5 Volt (V) carbon or alkaline batteries, or multiples of 1.2 Volt nickel-metal hydride batteries, or multiples of 3.6 Volt Lithium-ion batteries. Other embodiments might target applications that utilize other commonly available power sources such as 3.3 V DC, 5 V DC or 12 V DC commonly found in computers, 12 VAC or 24 VAC at 50-60 Hz commonly found in low voltage lighting systems, or 115 VAC at 400 Hz used in aircraft or any other voltage level, AC or DC. The design of the power converter 103 depends on the power requirement of the particular visible light source 102 and the power received by the external power contacts 104 and 105 for any particular embodiment. In some embodiments, the power converter 103 also may include the ability to dim the visible light source 102 depending on the particular characteristics of the power received by the external power contacts 104 and 105, such as the voltage level, pulse modulation or phase characteristics of the power received.

Also included in the lighting module 100 is a controller 107. The controller 107 is comprised of a receiver 108, a drive circuit 106, in some embodiments, a conversion circuit, and in yet other embodiments, circuitry to control the visible light source 102. The power converter 103 also provides power of the appropriate voltage and type for the controller 107.

The receiver 108 accepts data from a source outside of the lighting module for the controller 107. Depending on the embodiment, the data can be received using a variety of different protocols over a variety of different media as described later in this specification. The lighting module 100 has the capability to control consumer electronics equipment using the data received. In some embodiments, the data comes from the receiver 108 already in the proper protocol necessary to control the consumer electronics equipment so the controller passes the data from the receiver 108 directly to the drive circuit 106. In other embodiments, the data must be converted from one protocol to a different protocol by the conversion circuit in the controller 107 before it can be passed to the drive circuit 106. The drive circuit 106 modulates the data it receives with a carrier and drives the infrared LED 112. Some embodiments include a plurality of infrared LEDs 112 to provide modulated infrared light to a wider area.

The lighting module disclosed includes structure to integrate the various elements into an integrated unit. In some embodiments, the module may be a lighting fixture that is directly installed in a building or vehicle. In other embodiments, it may be implemented as a subassembly to be used in a larger lighting apparatus. In one embodiment, such as that shown in FIG. 1, the lighting module 100 is implemented as a light bulb that can be used in a standard socket. The bulb 101 surrounds the elements of the lighting module 100 and is made of a material to allow the light from both the visible light source 102 and infrared LED 112 to be emitted from the bulb 101 into the surrounding environment. The bulb could be made of glass, a polymeric material such as plastic, or any other transparent or translucent material. A base 111 is attached to the bulb 101 to allow it to be inserted into a standard lighting socket such as Edison screw fittings, bayonet sockets, pin connections, or any other type of connector. The base 111 includes the external power contacts 104 and 105 and in some embodiments may include additional contacts for power or data. The controller 107, in some embodiments, may be implemented on a circuit board 109. The circuit board 109 may also include the power converter 103. The circuit board 103 provides structure for the controller 107 and also may provide the electrical connection to the visible light source 102 and infrared LED 112. Additional members 110 may be used to connect the circuit board 109 to the base 111 and bulb 101.

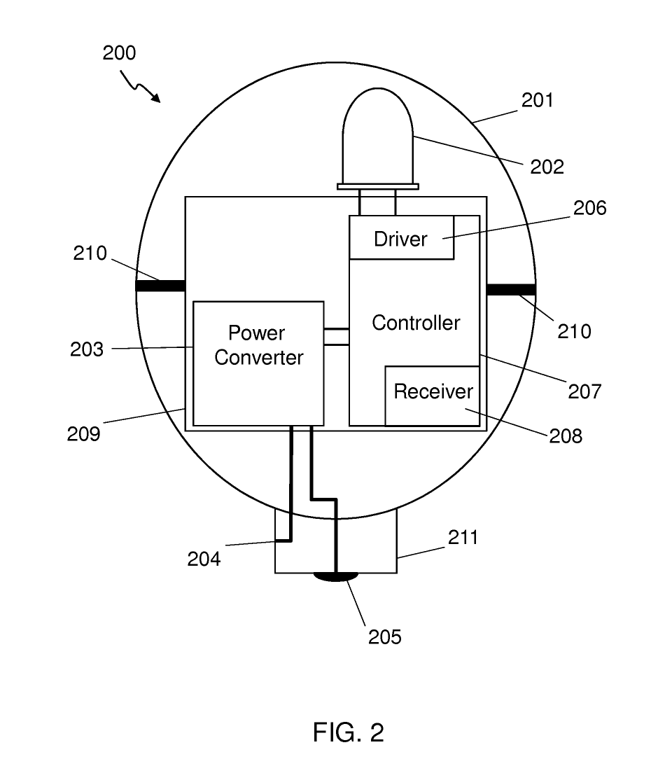

In an alternative embodiment shown in FIG. 2, lighting module 200 includes a broadband LED 202 that emits light in both the visible and infrared spectrum. The broadband LED 202 could be a single LED or a plurality of LEDs. It could be a phosphor LED that uses a phosphor or blend of phosphors to convert the light output of an LED to a broad spectrum output including visible light and infrared light. As an illumination source, the luminous flux output in the visible spectrum should be at least equivalent to a 5 W incandescent light, or 25 lumens or greater. In one embodiment, the broadband LED 202 emits white light in the visible spectrum as well as infrared light.

The broadband LED 202 is connected to a power converter 203 that receives electrical power from external power contacts 204 and 205. The electrical power received from the external power contacts 204 and 205 may be direct current (DC) or alternating current (AC) and may be one of many different voltages depending on the target application of a particular embodiment. Voltages that may be received from the external power contacts 204 and 205 include common household voltages of 100-250 Volts AC (VAC) at 50 or 60 Hz. They also might be common battery based voltages such multiples of 1.5 Volt (V) carbon or alkaline batteries, or multiples of 1.2 Volt nickel-metal hydride batteries, or multiples of 3.6 Volt Lithium-ion batteries. Other embodiments might target applications that utilize other commonly available power sources such as 3.3 V DC, 5 V DC or 12 V DC commonly found in computers, 12 VAC or 24 VAC at 50-60 Hz commonly found in low voltage lighting systems, or 115 VAC at 400 Hz used in aircraft or any other voltage level, AC or DC. The design of the power converter 203 depends on the power requirement of the particular broadband LED 202 and the power received by the external power contacts 204 and 205 for any particular embodiment. In some embodiments, the power converter 203 also may include the ability to dim the broadband LED 202 depending on the particular characteristics of the power received by the external power contacts 204 and 205, such as the voltage level, pulse modulation or phase characteristics of the power received.

Also included in the lighting module 200 is a controller 207. The controller 207 is comprised of a receiver 208, a drive circuit 206, circuitry to control the current on-off state of the lighting module 200, and, in some embodiments, a conversion circuit. The power converter 203 also provides power of the appropriate voltage and type for the controller 207.

The receiver 208 accepts data from a source outside of the lighting module and passes it into the controller 207. Depending on the embodiment, the data can be received using a variety of different protocols over a variety of different media as described later in this specification. The lighting module 200 has the capability to control consumer electronics equipment using the data received. In some embodiments, the data comes from the receiver 208 in the protocol necessary to control the consumer electronics equipment so the controller passes the data from the receiver 208 to the drive circuit 206. In other embodiments, the data must be converted from one protocol to a different protocol by the conversion circuit in the controller 207 before it can be passed to the drive circuit 206. The drive circuit 206 modulates the data it receives with a carrier and drives the broadband LED 202. Because the broadband LED 202 emits both visible light and infrared light, the visible light may flicker as the broadband LED 202 is modulated to control the infrared emission. To minimize this flickering, the controller 207 may turn the broadband LED 202 on or off to match the current on-off state between commands sent over the infrared using the consumer electronics control protocol.

The lighting module disclosed includes structure to integrate the various elements into an integrated unit. In some embodiments, the module may be a lighting fixture that is directly installed in a building or vehicle. In other embodiments, it may be implemented as a subassembly to be used in a larger lighting apparatus. In the embodiment shown in FIG. 2, the lighting module 200 is implemented as a light bulb that can be used in a standard socket. The bulb 201 surrounds the elements of the lighting module 200 and is made of a material to allow both the visible infrared light from the broadband LED 202 to be emitted from the bulb 201 into the surrounding environment. The bulb could be made of glass, a polymeric material such as plastic, or any other transparent or translucent material. A base 211 is attached to the bulb 201 to allow it to be inserted into a standard lighting socket such as Edison screw fittings, bayonet sockets, pin connections, or any other type of connector. The base 211 includes the external power contacts 204 and 205 and in some embodiments may include additional contacts for power or data. The controller 207, in some embodiments, may be implemented on a circuit board 209. The circuit board 209 may also include the power converter 203. The circuit board 203 provides structure for the controller 207 and also may provide the electrical connection to the broadband LED 202. Additional members 210 may be used to connect the circuit board 209 to the base 211 and bulb 201.

The operation of the controller 107 shown in FIG. 1 and controller 207 shown in FIG. 2 are very similar in nature since they are performing the same operations in a slightly different overall embodiment. So for ease of understanding, the description of the following figures refer only to the blocks shown in FIG. 1. But it should be understood that the descriptions equally well apply to the blocks of FIG. 2 unless otherwise stated.

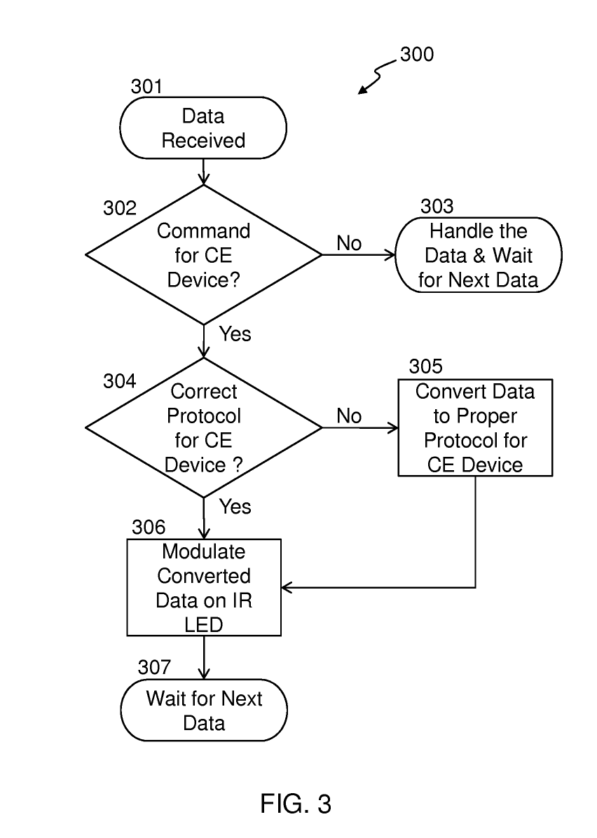

FIG. 3 shows a simplified flowchart 300 of the operation of the controller 107. The first event 301 occurs when data is received by the data receiver 108 to start the operation of the flowchart 300. At a decision point 302, the data is analyzed to see if it contains a command meant for a consumer electronic component. If it is not a command meant for a consumer electronic component, the controller 107 takes whatever action 303 might be required by that data. The action 303 could be related to the on-off state of the visible light source 102 or visible light emission of broadband LED 202. The action 303 could also be related to the controller's communication with devices other than the consumer electronics component, collection of data from sensors located in the lighting module 100, or any other activity that might be allotted to the controller 107 to perform. Once the action 303 dictated has been performed, the controller 107 waits for the next data from the receiver 108.

If, on the other hand, the data received at the first event 301 is determined to be a command for a consumer electronics component at the decision point 302, the controller 107 takes the step 304 of evaluating the data received to determine if it needs to be translated to a different protocol to be able to control the targeted consumer electronics component. In some embodiments, as is taught by Dockery, the incoming data may already be of the correct protocol to be sent to the consumer electronics component. In this case, the data to be modulated is essentially the same as the incoming data. It may be buffered or delayed due to the processing steps 301-306 but the data streams will contain the same data unchanged. In other embodiments, such as is taught by Stevenson, et al., some very simple processing needs to be performed by the controller 107 on the data to remove tags or headers to put the incoming data into the correct protocol. In yet other embodiments, the controller 107 needs to perform much more elaborate processing such as looking up the correct command data payload and protocol in a local memory device, based on the intended function for a particular the brand and model of consumer electronics component targeted. If a conversion needs to be performed, the controller 107 converts the data 305. If the data was already in the proper protocol or after the data has been converted 305 the step 306 is taken to modulate a carrier with the converted data to generate a signal to drive the infrared LED 112 or broadband LED 202. The controller 107 then waits 306 for the next data to be received.

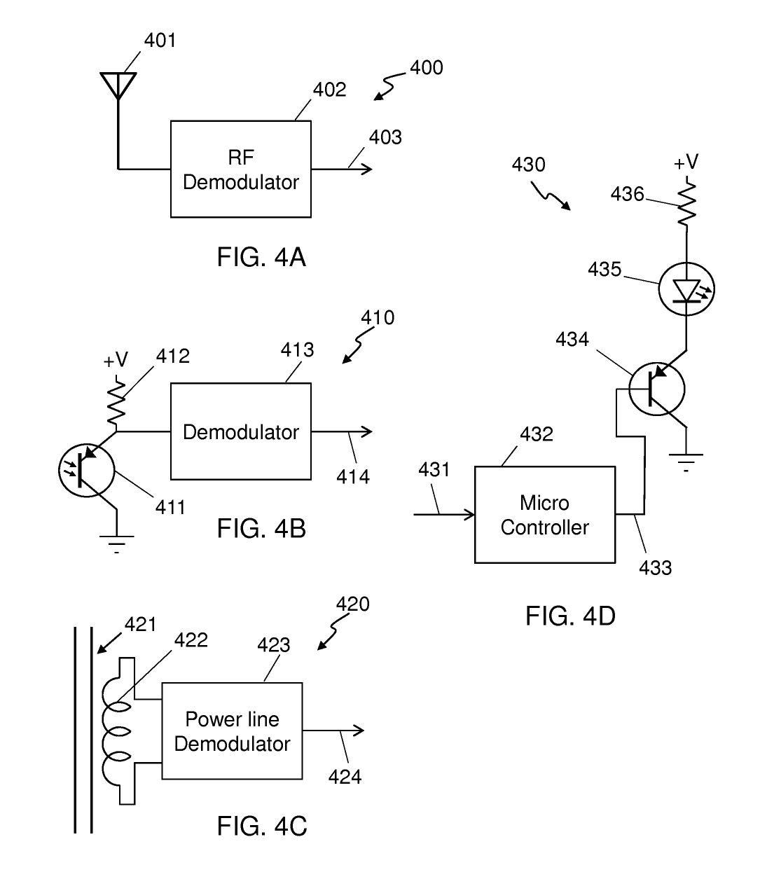

A more detailed view of the controller 107 is shown in FIG. 4. Alternative embodiments of the receiver 108 are shown in FIGS. 4A, 4B and 4C. FIG. 4D shows the rest of the controller 107 for one embodiment, including the drive circuit 106. The embodiment of the receiver 400 shown in FIG. 4A is directed toward receiving data from a radio frequency source. The antenna 401 captures the modulated radio frequency signal and sends it to the RF demodulator 402 to demodulate the data from the carrier frequency. The data is then sent on by the data port 403. The radio frequency signal could be a standard protocol including, but not limited to, IEEE 802.11 (Wi-Fi), X10 wireless, Z-Wave or IEEE 802.15 (ZigBee). Some embodiments could utilize a proprietary signaling protocol. In some embodiments, the radio frequency receiver 400 could actually be a transceiver capable of both receiving and transmitting data and participating in 2-way communication using radio frequency communication. The radio frequency receiver 400 in some embodiments may be a node in a data network having a mesh topology where some packets of data are used to control aspects of the lighting module 100 while others are simply passed along to another device in the network.

FIG. 4B is addressed to an embodiment of the receiver 410 that receives data from an optical source. A phototransistor 411 is sensitive to the amount of light received. In some embodiments, the phototransistor 411 is sensitive to visible light and in others, it is sensitive to ultraviolet light. In yet other embodiments, the phototransistor 411 is sensitive to infrared light. A resistor 412 is connected between a voltage source and the phototransistor 411 causing the voltage level of the signal sent to a demodulator 413 to be proportional to the amount of the selected spectrum of light that is directed to the phototransistor 411. The demodulator 413 recovers the data that was modulated with a carrier waveform and sends it on through the data port 414. The incoming optical signal could be modulated using a consumer electronics control protocol, a standard protocol such as that defined by the Infrared Data Association (IRDA), or some other standard or proprietary optical signaling protocol.

In yet another embodiment shown in FIG. 4C, the receiver 420 may decouple a signal from the incoming power line 421 and demodulate that to retrieve the data. Inductive element 422 is placed in close proximity to the power line 421. This allows the inductive element 422 to couple with the magnetic flux of any signal embedded on the power line 421 and send that signal to the power line demodulator 423 to be recovered. The demodulated data is then sent out through the data port 424. Signaling protocols that may be coupled to the incoming power line include X10, HomePlug or other standard or proprietary power line signaling protocols. In some embodiments, the power line receiver 420 could actually be a transceiver capable of both receiving and transmitting data and participating in 2-way communication using power line signaling.

In other embodiments, the data receiver 106 may have a wired baseband connection to a data bus or network such as USB or Ethernet. It can be a transceiver or be limited to receiving data only.

The rest of the controller 430 is shown in FIG. 4D. The incoming data port 431 receives data from the receiver's output data port 403, 414 or 424. In some embodiments, where the incoming data is already in if proper protocol to control the consumer electronics component, the receiver's output data port 403, 414 or 424 may be directly connected to the drive circuit signal 433. In other embodiments, discrete circuitry may be employed to convert the data. In other embodiments, a microcontroller 432 or other programmable element is used to convert the data. In some embodiments, some of the receiver functionality or some of the drive circuit functionality may also be included in the microcontroller 432. The microcontroller 432 may integrate random access memory (RAM) or read only memory (ROM) although in some embodiments, RAM or ROM may be separate integrated circuits. The ROM may contain an executable program that is comprised of instructions to allow the microcontroller 432 to perform functions such as, but not limited to, demodulating the incoming signal, converting the data received on the incoming data port 431 to the proper protocol to control a consumer electronics component, executing a network protocol stack, controlling the visible light source 102, or modulating a carrier with data in the proper protocol to control a consumer electronics component. Converting the data received on the incoming data port 431 to the proper protocol to control a consumer electronics component can take many different forms, depending on the embodiment. In some embodiments, it is simply removing tags or headers from the data. In other embodiments, it may involve taking information on the function being requested and using information on the brand and model of the consumer electronics component to look up the proper data protocol. In yet other embodiments, a complex series of commands targeted to a plurality of consumer electronics components, sometimes called a macro, may be initiated from a single incoming command.

Once the data has been put into the proper protocol to control the consumer electronics component, the data is used to modulate a carrier. In the embodiment shown in FIG. 4D, the modulation is performed in the microcontroller 432 and the modulated signal is output to the drive circuit signal 433. The drive circuit signal 433 is used to drive a switch, a pnp transistor 434 in this embodiment, that controls the current flowing through an infrared LED 435 that is connected to a voltage source through a resistor 436. The output of the infrared LED 435 is then sent out from the lighting module 100 to any consumer electronics component that may be struck by the infrared light.

Many standard electronics components can be controlled by a modulated infrared light source. Many different protocols are used with many brands developing their own proprietary protocols. Some common protocols in use by the industry were initially developed by NEC, JVC, Nokia, Sharp, RCA, Bang and Olufsen, Pioneer, Sony and others. Philips developed several different protocols with names such as RC-5, RC-6, RC-MM, and RECS80. Many manufacturers now use a protocol originally defined by another company. While these protocols are somewhat different from each other, they share a common traits of being uni-directional and modulating the data on a carrier before sending it out as infrared light. Most of these protocols do not have strict requirements on the frequency of the carrier, so it can vary quite widely, but most protocols use a carrier with a frequency of between 30 and 60 kHz with the most common carrier frequency being 38 kHz. A few protocols, such as those developed by Pioneer as well as Bang and Olufsen, utilize much higher frequency carriers such as 455 kHz or 1125 kHz. Some protocols use 100% amplitude-shift keying (ASK) modulation where the presence of the carrier indicates a binary one (1) and the absence of the carrier indicates a binary zero (0) although some protocols me use other modulation techniques. Some protocols use the length of the time between burst of carrier pulses to encode data.

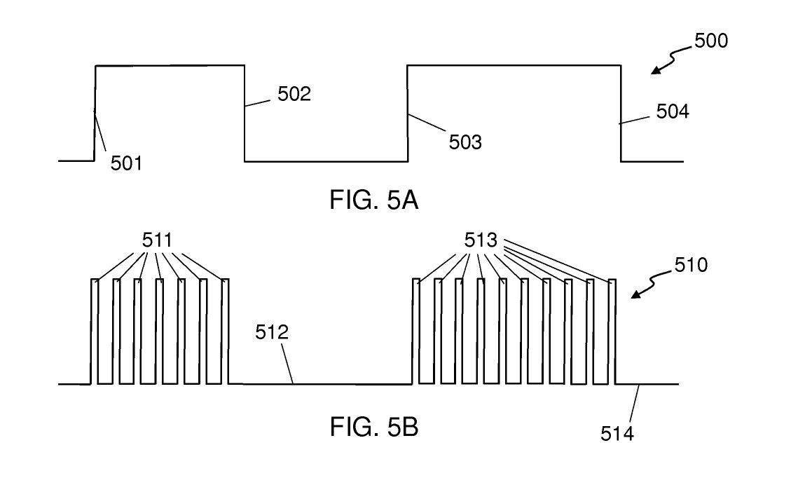

FIGS. 5A and 5B show a simplified version of a modulation scheme that is typical of protocols used to modulate infrared control signals for consumer electronic components. FIG. 5A shows a small portion of the data stream waveform 500 after it has been converted into a protocol for controlling a consumer electronics component. In this example, the signal starts at zero at time T0 (the beginning of the waveform), goes from zero to one at a time T1 501, back to zero at time T2 502, toggles back to one at time T3 503 and then back to zero at time T4 504. The exact sequence of ones and zeros and the timing of the transitions are specific to each protocol and are not discussed in detail here as they are well known to those skilled in the art.

FIG. 5B shows a portion of the drive circuit waveform 510 that is used to drive the infrared LED 435. For clarity, the drive circuit waveform 510 shown in FIG. 5B, based on the portion of the data stream waveform 500, is actually the inverse of the signal that needs to be present on the drive circuit signal 433 shown in the specific embodiment of FIG. 4D since the infrared LED 435 turns on if the drive circuit signal 433 is low and turns off if the drive circuit signal 433 is high. At the beginning of the sequence, at time T0, the drive circuit waveform 510 is quiescent with no carrier signal present. At time T1 501, the carrier is enabled on the drive circuit waveform 510 with carrier pulses 511. The time between the carrier pulses is determined by the carrier waveform frequency. At time T2 502, as the data steam waveform 500 goes back to zero, the carrier pulses are turned off and the drive circuit waveform 510 is quiescent again 512. At time T3 503, as the data stream waveform 500 goes back to one, the carrier pulses 513 are enabled again and at time T4 504, the carrier pulses are once again disabled and the drive circuit waveform 510 is quiescent 514 again.

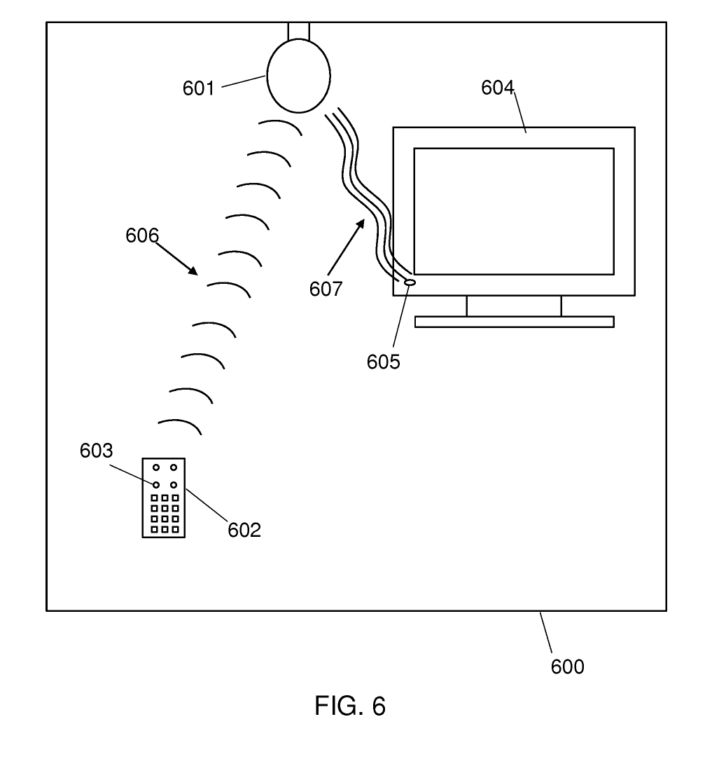

FIG. 6 depicts a room 600 where a lighting module 601 of the present disclosure is included. The lighting module 601 is able to illuminate the room with visible light (not shown). Some device, in this example, a remote control 602 with at least one button 603 is set up to control the consumer electronics component, in this example a television 604 with an IR receiver 605. In this example, the remote control 602 is not the remote control that was provided with the television 604, but is a more capable Zigbee device that sends out commands using radio frequency signals 606. The lighting module 601 in this example has a receiver that is also a Zigbee device that can receive radio frequency signals. The remote control 602 and lighting module 601 can be full function Zigbee devices, or reduced function Zigbee devices and may or may not include coordinator functionality. The Zigbee network may be configured as any supported topology such as a star, a mesh, or a cluster tree. The television 604 is not a Zigbee device and can only be controlled through physical switches on the television 604 itself or by IR commands received by the IR receiver 605. Other embodiments may use a Z-wave mesh network.

If a button 603 is pressed, the remote control 602 sends out a pre-programmed command using a radio frequency signal 606. In this example, the radio frequency signal 606 is sent directly to the lighting module 601 but in other situations, the command could be relayed between other devices in the network from the originating source to the lighting module 601. The originating source could be any type of device, including a remote control 602 as shown in this example, a personal computer, a smart wall-mounted light switch, a control panel, another consumer electronics component, or any other type of device, The originating device could be in the illumination area of the lighting module 601, but it also could be in the same room 600 but out of the illumination area of lighting module 601, or somewhere outside of the room 600 which is also outside of the illumination area of lighting module 601.

When the command is received at the lighting module 601, it processes the command to convert it into the proper protocol to control the television 604. The information required to determine the proper protocol to control the particular television 604 is either pre-programmed into the lighting module 601 or included in the command received over the radio frequency signal 606. The lighting module 601 then modulates the converted command onto an infrared light beam 607 which is then sent to the IR receiver 605 of the television 604. Note that the television 604 must be placed in a position so that the infrared light beam 607 sent from the lighting module 601 can be received by the IR receiver 605. Once the IR command has been received, the television 604 executes the command such as turning the picture and sound on or off, changing channels, changing the volume level, or any other function that can be controlled using IR commands on the particular television 604.

In one embodiment, a remote control may be a legacy IR remote sending out commands using a consumer electronics protocol. It is in a first room with a first lighting module. A second lighting module is located in a second room. A consumer electronics component, in this case an AV receiver driving a set of speakers in the first room, is located in a third room with a third lighting module. If the user decides that they want to increase the volume while in the first room, they can hit the volume up button on their remote control which sends out an IR command using a consumer electronics protocol. The first lighting module receives the IR command and decides that it is targeted at a device in another room. It can make that decision based on system configuration information that has been stored in the first lighting module. Or it could query a central network controller to decide where the IR command should be routed. Once it determines that the IR command should be sent to another room, it take the IR command information and packages it into a message that is then sent out over the network. In one embodiment, the network is a mesh network, so the packet is first broadcast to the second lighting module in the second room. It examines the packet and determines that it should be sent on to the third room, so it forwards the packet to the third lighting module in the third room. When the third lighting module receives the packet, it determines that the command is meant for the third room, retrieves the IR command information from the packet, converts it into the proper IR protocol and modulates a carrier with the data, sending the modulated data out using its own IR LED. The reconstituted IR command is then received by the AV receiver which then raises the volume of the speakers in the first room.

It should be noted that this disclosure is addressed to controlling consumer electronics components that receive IR commands but do not send out control information themselves. Specifically, the device receiving the IR command, in this example the television 604, does not communicate back to the lighting module 601.

Unless otherwise indicated, all numbers expressing quantities of elements, optical characteristic properties, and so forth used in the specification and claims are to be understood as being modified in all instances by the term “about.” Accordingly, unless indicated to the contrary, the numerical parameters set forth in the preceding specification and attached claims are approximations that can vary depending upon the desired properties sought to be obtained by those skilled in the art utilizing the teachings of the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

The recitation of numerical ranges by endpoints includes all numbers subsumed within that range (e.g. 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. Thus, for example, reference to an element described as “an LED” may refer to a single LED, two LEDs or any other number of LEDs. As used in this specification and the appended claims, the term “or” is generally employed in its sense including “and/or” unless the content clearly dictates otherwise.

Any element in a claim that does not explicitly state “means for” performing a specified function, or “step for” performing a specified function, is not to be interpreted as a “means” or “step” clause as specified in 35 U.S.C. §112, ¶ 6. In particular the use of “step of” in the claims is not intended to invoke the provision of 35 U.S.C. §112, ¶ 6.

The description of the various embodiments provided above is illustrative in nature and is not intended to limit the invention, its application, or uses. Thus, variations that do not depart from the gist of the invention are intended to be within the scope of the embodiments of the present invention. Such variations are not to be regarded as a departure from the intended scope of the present invention.

What is claimed is:

1. A lighting module comprising:
a visible light source outputting 25 lumens or more of luminous flux;
an infrared LED;
a controller comprising a data receiver and a drive circuit;
structure to join the visible light source, the infrared LED and the controller into an integrated unit; wherein
the data receiver receives a first data stream from a source outside the lighting module; and
the drive circuit controls the infrared LED to transmit a second data stream modulated to control a consumer electronics component, the consumer electronics component separate from the source outside the lighting module that generates the first data stream.

2. The lighting module of claim 1 in which the visible light source is comprised of at least one LED.

3. The lighting module of claim 1 in which the visible light source outputs white light.

4. The lighting module of claim 1 in which the data receiver demodulates a radio frequency signal.

5. The lighting module of claim 1 in which the data receiver demodulates an optical signal.

6. The lighting module of claim 5 in which the optical signal is in the infrared spectrum.

7. The lighting module of claim 6 in which the optical signal is modulated to control the consumer electronics component.

8. The lighting module of claim 5 in which the optical signal is in the ultraviolet spectrum.

9. The lighting module of claim 1 in which the data receiver demodulates a signal that has been decoupled from a power line.

10. The lighting module of claim 1 in which the second data stream is essentially the same as the first data stream.

11. The lighting module of claim 1 in which the controller is comprised of a microcontroller.

12. The lighting module of claim 11 in which the microcontroller converts the first data stream into the second data stream.

13. The lighting module of claim 1 in which the controller further comprises circuitry to control an on-off state of the visible light source.

14. The lighting module of claim 1 in which drive circuit modulates a 30-60 kHz carrier signal with the second data stream to control the consumer electronics component.

15. The lighting module of claim 1 in which drive circuit modulates a carrier signal with the second data stream to control the consumer electronics component, the carrier signal having a frequency selected from the group consisting of 455 kHz and 1125 kHz.

16. The lighting module of claim 1 in which the structure comprises:
a base with electrical contacts for connecting to an external power source;
a circuit board, at least the controller mounted on the circuit board;
an shell that is attached to the base and contains the circuit board, the visible light source, and the infrared LED, the shell allowing the 25 lumens or more of luminous flux from the visible light source and the second data stream modulated to control the consumer electronics component transmitted from the infrared LED to emerge from the shell.

17. The lighting module of claim 16 in which at least a part of the shell is made of glass.

18. The lighting module of claim 16 in which at least a part of the shell is made of a polymeric material.

19. A lighting module comprising:
an LED outputting both visible light and infrared light, wherein the LED provides 25 lumens or more of luminous flux in the visible spectrum;
a controller comprising a data receiver and a drive circuit;
structure to join the at LED and the controller into an integrated unit; wherein
the data receiver receives a first data stream from a source outside the lighting module; and
the drive circuit controls the LED to transmit a second data stream modulated to control a consumer electronics component, the consumer electronics component separate from the source outside the lighting module that generates the first data stream.

20. The lighting module of claim 19 in which the visible light is white light.

21. The lighting module of claim 19 in which the data receiver demodulates a radio frequency signal.

22. The lighting module of claim 19 in which the data receiver demodulates an optical signal.

23. The lighting module of claim 22 in which the optical signal is modulated to control the consumer electronics component.

24. The lighting module of claim 19 in which the data receiver demodulates a signal that has been decoupled from a power line.

25. The lighting module of claim 19 in which the second data stream is a buffered version of the first data stream.

26. The lighting module of claim 19 in which the controller further comprises a conversion circuit that converts the first data stream into the second data stream.

27. The lighting module of claim 19 in which drive circuit modulates a carrier signal with the second data stream to control the consumer electronics component, the carrier signal having a frequency selected from the group consisting of 30-60 kHz, 455 kHz and 1125 kHz.

28. The lighting module of claim 19 in which controller is comprised of a microcontroller.

29. The lighting module of claim 28 in which the microcontroller further controls a current on-off state of the LED and sets the LED to the current on-off state between commands sent to control the consumer electronics component.

30. The lighting module of claim 19 in which the structure comprises:
a base with electrical contacts for connecting to an external power source;
a circuit board, at least the controller mounted on the circuit board;
an shell that is attached to the base and contains the circuit board and the LED, the shell allowing the 25 lumens or more of luminous flux from the visible light source and the second data stream modulated to control the consumer electronics component from the infrared LED to emerge from the shell.

31. An integrated lighting unit comprising:
means for emitting visible light, the visible light outputting 25 lumens or more of luminous flux;
means for emitting infrared light;
means for receiving a first data stream from a source outside the integrated lighting unit;
means to convert the first data stream to a second data stream; and
means for modulating the infrared light to transmit the second data stream to control a consumer electronics component.

32. The integrated lighting unit of claim 31 in which means for receiving a first data stream demodulates a radio frequency signal.

33. The integrated lighting unit of claim 31 in which means for receiving a first data stream demodulates a signal that has been decoupled from a power line.

34. The integrated lighting unit of claim 31 further comprising means to control the on-off state of the visible light.

35. The integrated lighting unit of claim 31 wherein the infrared light is modulated using a 30-60 kHz carrier signal.

36. A light bulb comprising:
a plurality of visible light LEDs with a total combined light output of at least 25 lumens;
an infrared LED;
a microcontroller and additional circuitry providing at least:
(a) a radio frequency transceiver capable of connecting to a radio frequency network;
(b) a lighting controller utilizing data received from the radio frequency network to control an on-off state of the plurality of visible light LEDs;
(c) a data converter converting data received from the radio frequency network to a data stream with a proper protocol to control a consumer electronics component;
(d) a drive circuit driving the LED with a signal comprising a carrier waveform modulated with the data stream with the proper protocol to control the consumer electronics component;
a base with an electrical power connection; and
a shell connected to the base, the shell at least partially transparent to visible and infrared light and containing the plurality of visible light LEDs, the infrared LED and the microcontroller and additional circuitry.

37. The light bulb of claim 36 wherein the radio frequency network utilizes a mesh topology.

38. The light bulb of claim 36 wherein the lighting controller further controls a color temperature of the combined light output of the plurality of visible light LEDs.

39. The light bulb of claim 36 wherein carrier waveform has a frequency of 30-60 kHz.

40. A lighting fixture comprising:
A socket with electrical contacts for accepting a separate visible light source;
an infrared LED;
a controller comprising a data receiver and a drive circuit;
structure to join the socket, the infrared LED and the controller into an integrated unit; wherein
the data receiver receives a first data stream from a source outside the lighting fixture; and
the drive circuit controls the infrared LED to transmit a second data stream modulated to control a consumer electronics component, the consumer electronics component separate from the source outside the lighting fixture that generates the first data stream.

41. The lighting fixture of claim 40 in which the data receiver demodulates a radio frequency signal.

42. The lighting fixture of claim 40 in which the data receiver demodulates an optical signal.

43. The lighting fixture of claim 42 in which the optical signal is in the infrared spectrum.

44. The lighting fixture of claim 43 in which the optical signal is modulated to control the consumer electronics component.

45. The lighting fixture of claim 42 in which the optical signal is in the ultraviolet spectrum.

46. The lighting fixture of claim 40 in which the data receiver demodulates a signal that has been decoupled from a power line.

47. The lighting fixture of claim 40 in which the second data stream is essentially the same as the first data stream.

48. The lighting fixture of claim 40 in which the controller is comprised of a microcontroller that at least converts the first data stream into the second data stream.

49. The lighting fixture of claim 40 in which the controller further comprises circuitry to control an on-off state of the visible light source.

50. The lighting fixture of claim 40 in which drive circuit modulates a 30-60 kHz carrier signal with the second data stream to control the consumer electronics component.

51. The lighting fixture of claim 40 in which drive circuit modulates a carrier signal with the second data stream to control the consumer electronics component, the carrier signal having a frequency selected from the group consisting of 455 kHz and 1125 kHz.
